(19) United States
(12) Patent Application Publication
(10) Pub. No.: US 2006/0139513 A1
(43) Pub. Date: Jun. 29, 2006

(54) Tape

(75) Inventors: Che-Fu Chiu, Bade City (TW); Tung-Lung Li, Pingzhen City (TW); Long-Hai Wu, Tucheng City (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 11/189,862

(22) Filed: Jul. 27, 2005

(30) Foreign Application Priority Data
Dec. 28, 2004 (TW) 93140840

(51) Int. Cl. G02F 1/1335

(52) U.S. Cl. 349/106

(57) ABSTRACT

The present invention relates to a tape, comprising a color layer capable of displaying various colors with respect to different viewing angles, and at least one adhesive layer adhering to the color layer. The color layer is formed of at least two stacking materials, each having a refractive index different to that of another material adjacent thereto. In a preferred embodiment, the color layer is composed of a flexible substrate and at least one CLC layer while having the CLC layer adhering to the flexible substrate.

### FIELD OF THE INVENTION

The present invention relates to a tape, and more particularly, to a tape with color layer, capable of showing various colors with respect to different viewing angles.

### BACKGROUND OF THE INVENTION

There are many types of liquid crystal phases, such as NLC (nematic liquid crystal) phase, SLC (smectic liquid crystal) phase, CLC (cholesteric liquid crystal) phase and so on. Among these, the CLC phase is typically composed of nematic mesogenic molecules containing a chiral center which produces intermolecular forces that favor alignment between molecules at a slight angle to one another. This leads to the formation of a structure which can be visualized as a stack of very thin 2-D nematic-like layers with the director in each layer twisted with respect to those above and below. In this structure, the directors actually form in a continuous helical pattern about the layer normal with a pitch D, which is defined as the distance it takes for the director to rotate one full turn in the helix, as illustrated in FIG. 1. The CLC with different pitch lengths will have different optical characteristics.

The CLC can be applied in many applications, such as polarizer, head-up display, and liquid crystal display (LCD). Since CLC has the optical characteristics of memorization, bistable state (i.e. the optical phenomenon with two stable transmission states), selective optical scattering, circular polarized dichromic state, optical rotation, and so on, It is especially suitable for displaying color images.

The conventional transparent color tapes can be divided into two categories, i.e. monochrome and polychrome. There are two methods to make the monochrome tape: (1) applying the pressure sensitive adhesive on color substrates; (2) applying the pressure sensitive adhesive doped with dye on a transparent substrate. To fabricate the polychrome tape, substrates in different colors are adhered to each other, and then the needed pressure sensitive adhesive or the pressure sensitive adhesive doped with dye is applied thereon.

However, the conventional transparent tape can just display a stationary dull color, no matter it is being viewed by any viewing angles. They are incapable of exhibiting a variety of colors.

As a result of this drawback, the present invention is to provide a tape capable of displaying a variety of colors with respect to different viewing angles so as to improve the use thereof and to attain a brilliant visual effect.

### SUMMARY OF THE INVENTION

It is the primary object of the invention to provide a tape, which has a color layer that can display a variety of colors with respect to different viewing angles, and the color layer utilizes the optical characteristics of films or CLCs to achieve the purpose of displaying specific colors.

To achieve the above object, the present invention provides a tape, which comprises a color layer that can display a variety of colors with respect to different viewing angles and at least one adhesive layer adhered with the color layer.

Preferably, the color layer is formed of at least two stacking materials, each having a refractive index different to that of another material adjacent thereto.

Preferably, the materials are able to be passed through by light.

Preferably, the at least one adhesive layer is the pressure sensitive adhesive.

Preferably, the color layer further comprises a flexible substrate and at least one CLC layer that can be adhered with the flexible substrate.

Preferably, the flexible substrate is able to be passed through by light.

Preferably, the tape is further comprising a protecting layer adhered with the color layer.

Preferably, the protecting layer is made of plastic.

Other objects, advantages and novel characteristics of the invention will become more apparent from the following detailed description when taken in conjunction with the accompanying drawings, in which:

### BRIEF DESCRIPTION OF THE DRAWINGS

FIG. 1 is a cross section view of the conventional field emission display;

FIG. 2 is a schematic section view of the tape of the invention, which illustrates the first embodiment;

FIG. 3 is a partial enlarged schematic view of the tape of the invention, which illustrates the first embodiment;

FIG. 4 is a schematic section view of the tape of the invention, which illustrates the second embodiment;

FIG. 5 is a partial enlarged schematic view of the tape of the invention, which illustrates the second embodiment; and

FIG. 6 is a modified schematic view of the tape of the invention.

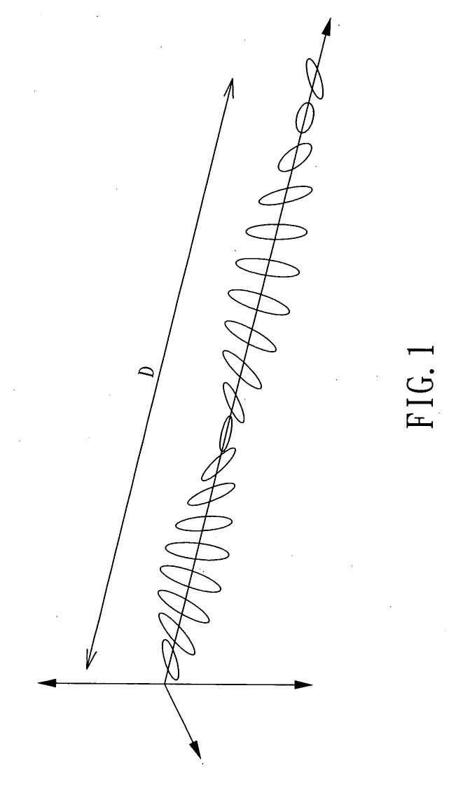

### DESCRIPTION OF THE PREFERRED EMBODIMENT

For your esteemed members of reviewing committee to further understand and recognize the fulfilled functions and structural characteristics of the invention, several preferable embodiments cooperation with detailed description are presented as the follows.

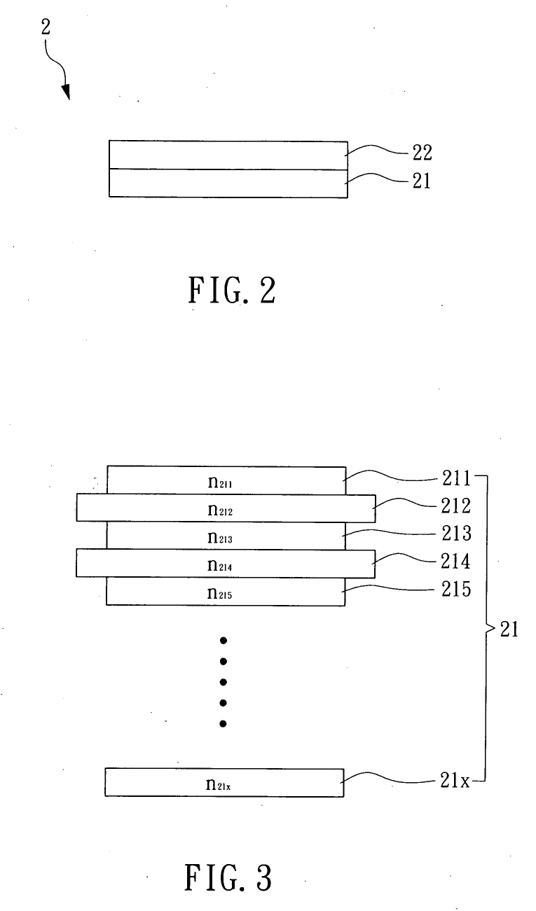

FIG. 2 is a schematic section view of the tape of the invention, which illustrates the first embodiment. A tape 2 comprises a color layer 21 and an adhesive layer 22. The adhesive layer 22 is applied on the color layer 21 and then a thermal curing or UV curing is applied thereon so as to tightly adhere the adhesive layer 22 with the color layer 21.

FIG. 3 is a partial enlarged schematic view of the tape of the invention, which illustrates the first embodiment. The color layer 21 is made up of a plurality of color layers, and they can be conveniently designated as film 211, film 212, film 213, film 214, and so on to 21X, with refractive index n₂₁₁, a refractive index n₂₁₂, a refractive index n₂₁₃, a refractive index n₂₁₄, a refractive index n₂₁₅ . . . and a refractive index n_{21X}, respectively. As a result, any two adjacent films have different refractive indexes, for example, the refractive index n₂₁₁ is different to the refractive index n₂₁₂, the refractive index n₂₁₂ is different to the refractive index n₂₁₃, the refractive index n₂₁₃ is different to the refractive index n₂₁₄, the refractive index n₂₁₄ is different to the refractive index n₂₁₅ . . . and the refractive index n_{21X-1} is different to the refractive index n_{21X}. By such arrangement, the color layer 21 can display different colors with respect to different viewing angles so as to display a variety of colors.

In the preferable embodiment of the invention, two films with different refractive indexes are used, that is, the film 211, the film 213, the film 215 . . . are made by the same material so that the refractive index n₂₁₁, the refractive index n₂₁₃ , the refractive index n₂₁₅ . . . are the same, and the film 212, film 214 . . . are made by another material so that the refractive index n₂₁₂, the refractive index n₂ₗ₄ . . . are the same.

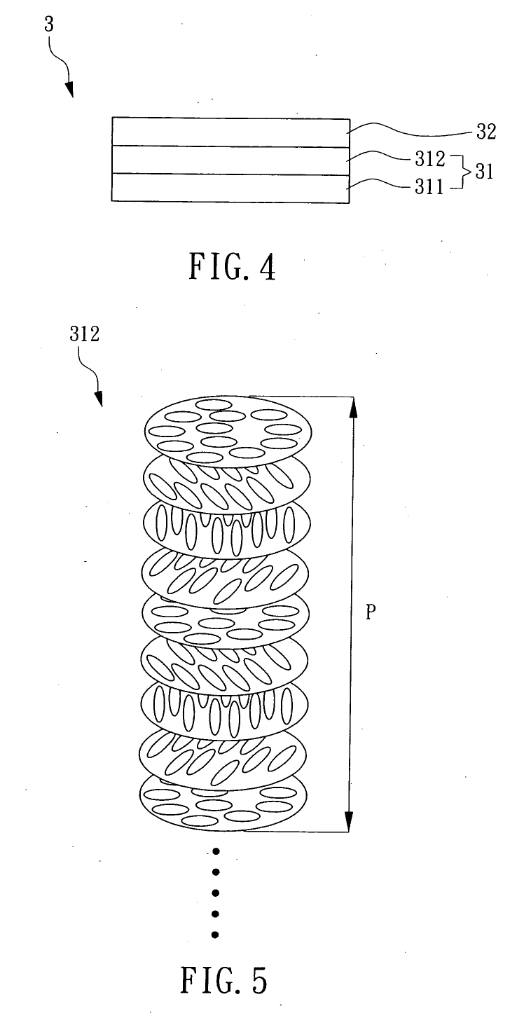

FIG. 4 is a schematic section view of the tape of the invention, which illustrates the second embodiment. Like FIG. 2, a tape 3 comprises a color layer 31 and an adhesive layer 32. The color layer 31 is made up of a substrate 311 and a CLC layer 312. First, the CLC layer 312 is applied and cured on the substrate 311, and subsequently the adhesive layer 32 is applied on the color layer 31 (the adhesive layer 32 can be applied on the CLC layer 312 or the substrate 311) and then a thermal curing or UV curing is applied thereon so as to tightly adhere the adhesive layer 32 to the color layer 31.

FIG. 5 is a partial enlarged schematic view of the tape of the invention, which illustrates the second embodiment. The CLC layer 312 is made up of multi-layer CLC and forms a structure of helix with a pitch P. Therefore, by choosing the proper material of the CLC layer 312 (i.e. choosing the distance of the pitch P), the tape (not shown) can display different colors with respect to different viewing angles within the visible light band.

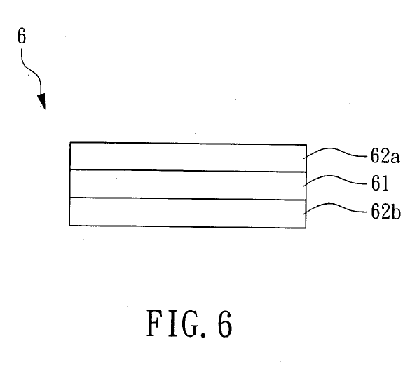

FIG. 6 is a modified schematic view of the tape of the invention. Differing from the single tape mentioned above, an adhesive layer 62a and an adhesive layer 62b can also be applied on both sides of the color layer 61 so as to form a double tape 6.

In the present invention, the adhesive layer is the conventional pressure sensitive adhesive (PSA) and the substrate is a flexible one. In the case of single tape, a protecting layer can be made adhering to the color layer, that is, one side of the color layer adhering to the adhesive layer and the other adhering to the protecting layer. The protecting layer can be made of transparent plastics.

Hence, the tape of present invention can achieve the effect of displaying different colors with respect to different viewing angles and can be modified at will according to the application. The invention is a novel technique in the related field and is with practicability.

While the preferred embodiment of the invention has been set forth for the purpose of disclosure, modifications of the disclosed embodiment of the invention as well as other embodiments thereof may occur to those skilled in the art. Therefore, the appended claims are intended to cover all possible embodiments which do not depart from the spirit and scope of the invention.

What is claimed is:

1. A tape, comprising:
a color layer capable of displaying a variety of colors with respect to different viewing angles; and
at least one adhesive layer adhering to the color layer.

2. The tape of claim 1, wherein the color layer is formed by stacking at least two materials, each having a refractive index different to that of another material adjacent thereto.

3. The tape of claim 2, wherein the materials can be passed through by light.

4. The tape of claim 1, wherein at least one of the adhesive layers is a pressure sensitive adhesive.

5. The tape of claim 1, wherein the color layer further comprises:
a flexible substrate; and
at least one CLC layer, adhering to the flexible substrate.

6. The tape of claim 5, wherein the flexible substrate can be passed through by light.

7. The tape of claim 1, further comprising:
a protecting layer, adhering to the color layer.

8. The tape of claim 7, wherein the protecting layer is made of plastic.
